(19) United States
(12) Patent Application Publication
(10) Pub. No.: US 2026/0070806 A1
(43) Pub. Date: Mar. 12, 2026

(54) CATHODE ACTIVE MATERIAL FOR LITHIUM SECONDARY BATTERIES, ELECTRODE FOR LITHIUM SECONDARY BATTERIES, AND LITHIUM SECONDARY BATTERY

(71) Applicant: SUMITOMO CHEMICAL COMPANY, LIMITED, Tokyo (JP)

(72) Inventors: Keisuke HORI, Niihama-shi (JP); Takuya KADOWAKI, Niihama-shi (JP); Ryo KURIKI, Niihama-shi (JP); Jun-ichi KAGEURA, Niihama-shi (JP)

(21) Appl. No.: 19/108,473

(22) PCT Filed: Sep. 1, 2023
(86) PCT No.: PCT/JP2023/032115

§ 371 Date: Mar. 4, 2025

(30) Foreign Application Priority Data
Sep. 7, 2022 (JP) 2022-142158

(51) Int. Cl. C01G 53/504; H01M 10/052

(52) U.S. Cl. CPC C01G 53/504; H01M 10/052; C01P 2002/85; C01P 2004/45; C01P 2004/51; C01P 2006/12; C01P 2006/40

(57) ABSTRACT

A cathode active material for lithium secondary batteries contains secondary particles which are an aggregate of primary particles, in which the cathode active material for lithium secondary batteries has a layered structure, the cathode active material for lithium secondary batteries contains an element M1 and an element M2, the element M1 is at least one element selected from the group consisting of Nb, W, Mo, Ta, La, B, and P, the element M2 is at least one element M2 selected from the group consisting of Ni, Co, and Mn, and (1) and (2) are satisfied.

### TECHNICAL FIELD

The present invention relates to a cathode active material for lithium secondary batteries, an electrode for lithium secondary batteries, and a lithium secondary battery.

Priority is claimed on Japanese Patent Application No. 2022-142158, filed on Sep. 7, 2022, the content of which is incorporated herein by reference.

### BACKGROUND ART

As the lithium secondary battery, a configuration including a cathode having a cathode active material, an anode, and an electrolyte in contact with the cathode and the anode is known.

As the electrolyte used in the lithium secondary battery, an electrolytic solution containing an organic solvent or a solid electrolyte is known. In the following description, the electrolytic solution and the solid electrolyte may be collectively referred to as “electrolyte”.

At an interface between the cathode and the electrolyte, the cathode active material included in the cathode and the electrolyte are in contact with each other. In the lithium secondary battery, extraction of lithium ions from the cathode active material into the electrolyte and insertion of lithium ions from the electrolyte into the cathode active material are performed according to charging and discharging of the battery. Therefore, physical properties of a surface of the cathode active material are closely related to the insertion and extraction of lithium ions.

On the other hand, it is known that, in a case where the cathode active material and the electrolyte are in direct contact with each other, a side reaction occurs during the charging and discharging, and battery characteristics are deteriorated. As the side reaction, in a case where the electrolyte is an electrolytic solution, for example, a reaction in which gas is generated in association with oxidative decomposition of the electrolytic solution is an exemplary example. The generated gas causes battery swelling.

In addition, in a case where the electrolyte is a solid electrolyte, for example, a side reaction in which the solid electrolyte is deteriorated at a portion where the solid electrolyte is in contact with the cathode active material and thus a resistance layer is formed is an exemplary example. The resistance layer to be formed inhibits movement of lithium ions. Here, the “resistance layer” is, for example, a layer having lithium ion conductivity.

In order to prevent the deterioration of battery characteristics, a method of providing a reaction-suppressing portion having lithium ion conductivity, between the cathode active material and the electrolyte has been studied in the related art. The reaction-suppressing portion protects the cathode active material, and the above-described side reactions are suppressed. For example, Patent Document 1 discloses composite active material particles including, on a surface thereof, a reaction-suppressing portion formed of lithium niobate.

### CITATION LIST

### Patent Document

Patent Document 1: Japanese Unexamined Patent Application, First Publication No. 2010-170715

### SUMMARY OF INVENTION

### Technical Problem

In a case where a reaction suppression portion is provided on the surface of the cathode active material as disclosed in Patent Document 1, the above-described side reactions are less likely to occur. However, the cathode active material including the reaction-suppressing portion tends to have a high lithium ion conduction resistance on the surface, and thus a charge and discharge capacity tends to decrease. Therefore, there is room for further improvement in order to exhibit a high capacity while suppressing the side reactions.

The present invention has been made in view of the above circumstances, and an object of the present invention is to provide a cathode active material for lithium secondary batteries in which a compound having excellent lithium ion conductivity is provided on a surface and inside of secondary particles, and in which lithium ions can smoothly move and a discharge capacity is high. Another object of the present invention is to provide an electrode for lithium secondary batteries and a lithium secondary battery in which the cathode active material for lithium secondary batteries is used.

### Solution to Problem

In order to achieve the above-described objects, the present invention includes the following aspects.
[1] A cathode active material for lithium secondary batteries, containing:
secondary particles which are an aggregate of primary particles,
in which the cathode active material for lithium secondary batteries has a layered structure,
the cathode active material for lithium secondary batteries contains an element M1 and an element M2,
the element M1 is at least one element selected from the group consisting of Nb, W, Mo, Ta, La, B, and P,
the element M2 is at least one element selected from the group consisting of Ni, Co, and Mn, and
the following (1) and (2) are satisfied,
(1) α, which is a ratio of an atomic concentration (atomic %) of the element M1 present on a surface of the secondary particles to a total amount of atomic concentrations (atomic %) of the element M1 and the element M2 present on the surface of the secondary particles, which are obtained by X-ray photoelectron spectroscopy (XPS) analysis, is 0.6 or more and 1 or less,
(2) β, which is a ratio of an atomic concentration (atomic %) of the element M1 present inside the secondary particles to a total amount of an atomic concentration (atomic %) of the element M2 and the atomic concentration (atomic %) of the element M1 present inside the secondary particles, which are obtained by the X-ray photoelectron spectroscopy (XPS) analysis, is 0.08 or more and 0.20 or less.
[2] The cathode active material for lithium secondary batteries according to [1],
in which a concentration portion of the element M1 is provided at a grain boundary of the primary particles in a cross section of the secondary particles, observed by transmission electron microscope-energy dispersive X-ray spectroscopy.
[3] The cathode active material for lithium secondary batteries according to [1] or [2],
wherein a content of Mn is 0.03 mol or more with respect to 1 mol of a total amount of the element M2.
[4] The cathode active material for lithium secondary batteries according to any one of [1] to [3],
in which the cathode active material for lithium secondary batteries is represented by the following compositional formula (I),

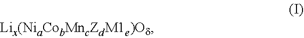

(in the compositional formula (I), 0.98≤x≤1.80, 0.3<a≤1, 0≤b≤0.3, 0.03≤c≤0.7, 0≤d≤0.05, 0<e≤0.05, a+b+c+d+e=1, and 2≤δ<3 are satisfied, Z is at least one element selected from the group consisting of Al, Zr, and Ti, and M1 is at least one element selected from the group consisting of Nb, W, Mo, Ta, La, B, and P).
[5] The cathode active material for lithium secondary batteries according to any one of [1] to [4],
in which S_{Li}, which is a ratio of an atomic concentration of Li present on the surface of the secondary particles to the atomic concentration of the element M1 present on the surface of the secondary particles, which are obtained by the X-ray photoelectron spectroscopy (XPS) analysis, is 1 or more and 4 or less.
[6] The cathode active material for lithium secondary batteries according to any one of [1] to [5],
in which I_{Li}, which is a ratio of an atomic concentration of Li present inside the secondary particles to the atomic concentration of the element M1 present inside the secondary particles, which are obtained by the X-ray photoelectron spectroscopy (XPS) analysis, is 10 or more and 50 or less.
[7] The cathode active material for lithium secondary batteries according to any one of [1] to [6],
in which a BET specific surface area is 0.2 m²/g or more and 2 m²/g or less.
[8] The cathode active material for lithium secondary batteries according to any one of [1] to [7],
wherein D₁₀, D₅₀, and D₉₀ satisfy the following (II),

$$( {D}_{90} - {D}_{10} ) / {D}_{50} \leq 1. , \qquad ( II )$$

(D₁₀ is a 10% cumulative volume particle size of the cathode active material for lithium secondary batteries, D₅₀ is a 50% cumulative volume particle size of the cathode active material for lithium secondary batteries, and D₉₀ is a 90% cumulative volume particle size of the cathode active material for lithium secondary batteries).
[9] The cathode active material for lithium secondary batteries according to any one of [1] to [8],
in which the cathode active material for lithium secondary batteries is for a solid lithium secondary battery.
[10] An electrode for lithium secondary batteries, containing:
the cathode active material for lithium secondary batteries according to any one of [1] to [9].
[11] A lithium secondary battery, including:
the electrode for lithium secondary batteries according to [10].

### Advantageous Effects of Invention

According to the present invention, it is possible to provide a cathode active material for lithium secondary batteries in which a compound having excellent lithium ion conductivity is provided on a surface and inside of secondary particles, and in which lithium ions can smoothly move and a discharge capacity is high. In addition, it is possible to provide an electrode for lithium secondary batteries and a lithium secondary battery in which the cathode active material for lithium secondary batteries is used.

### BRIEF DESCRIPTION OF DRAWINGS

FIG. 1 A schematic view representing an example of a lithium secondary battery.

FIG. 2 A schematic view representing an example of an all-solid-state lithium secondary battery.

### DESCRIPTION OF EMBODIMENTS

In the present specification, a metal composite compound will be referred to as “MCC”.

A cathode active material for lithium secondary batteries will be referred to as “CAM”.

The CAM according to the present embodiment contains secondary particles which are an aggregate of primary particles, and has a layered structure.

The CAM according to the present embodiment is an aggregate of a plurality of particles. One aspect of the CAM according to the present embodiment is powdery. In the present embodiment, the aggregate of a plurality of particles may include only the secondary particles or may be a mixture of the primary particles and the secondary particles.

In the present embodiment, the term “primary particles” means particles in which, apparently, no grain boundary is present at the time of observing the particles in a visual field of 1,000 times or more and 30,000 times or less using a scanning electron microscope or the like.

In the present specification, the term “secondary particles” means particles in which a plurality of the above-described primary particles are three-dimensionally aggregated to each other with a gap. That is, the secondary particles are an aggregate of the primary particles.

A notation “Li” does not indicate a Li metal single substance, but a Li element, unless particularly otherwise specified. The same applies to notations of other elements such as Ni, Co, Mn, Nb, W, Mo, Ta, La, B, and P.

In a case where a numerical range is described as, for example, “1 to 10 μm”, the numerical range means a range from 1 μm to 10 μm, and means a numerical range including 1 μm as a lower limit value and 10 μm as an upper limit value.

### <Cathode Active Material for Lithium Secondary Batteries>

The CAM according to the present embodiment contains an element M1 and an element M2.

The element M1 is at least one element selected from the group consisting of Nb, W, Mo, Ta, La, B, and P, and the element M2 is at least one element selected from the group consisting of Ni, Co, and Mn. The element M1 is preferably at least one element selected from the group consisting of Nb, W, and B, and the element M2 preferably includes Ni and at least one selected from the group consisting of Co and Mn.

In the CAM according to the present embodiment, the element M1 is present on the surface and inside the secondary particles. An example of the inside of the secondary particles is a grain boundary between the primary particles. In a case where the element M1 is present on the surface of the secondary particles, a portion where the element M1 is present can function as a protective film which suppresses side reactions. In a case where the element M1 is present inside the secondary particles, lithium ion conductivity inside the secondary particles is improved at a portion where the element M1 is present.

The present invention optimizes an uneven distribution state of the element M1 on the surface and inside the secondary particles.

Specifically, in the CAM according to the present embodiment, the element M1 and the element M2 are present on the surface of the secondary particles and inside the secondary particles with specific ratios.

(1)

In the CAM according to the present embodiment, a defined below is 0.6 to 1.

α is a ratio of an atomic concentration (atomic %) of the element M1 present on the surface of the secondary particles to the total amount (element M1+element M2) of the atomic concentration (atomic %) of the element M1 and the atomic concentration (atomic %) of the element M2 present on the surface of the secondary particles. That is, a is an atomic concentration ratio “Element M1/(Element M1+Element M2)” on the surface of the secondary particles.

In the present specification, the “surface” of the secondary particles means a range of approximately 10 nm in a depth direction from the surface of the secondary particles contained in the CAM toward a center of the particles.

The value of α is preferably 0.65 or more, more preferably 0.70 or more, and still more preferably 0.74 or more. In addition, the value of α is preferably 0.98 or less, more preferably 0.96 or less, and still more preferably 0.95 or less.

The above-described upper limit value and lower limit value thereof can be randomly combined. In the present embodiment, the value of α is preferably 0.65 to 0.98, more preferably 0.70 to 0.96, and still more preferably 0.75 to 0.95.

In a case where a is the above-described lower limit value or more, this means that a proportion of the element M2 exposed on the surface of the secondary particles contained in the CAM is small. In this case, decomposition of the CAM between the CAM and the electrolyte is suppressed, and a high discharge capacity is easily obtained.

In a case where a is the above-described upper limit value or less, this means that a depth of a region including the element M1 on the surface of the secondary particles contained in the CAM is shallow. During a charging and discharging reaction, lithium ions move between the electrolyte and the CAM in accordance with a change in the valence of the ions of the element M2. In this case, in a case where a is the above-described upper limit value or less, a distance between the ion of the element M2 and the electrolyte is short, that is, a distance of movement of the lithium ions is short, and thus diffusion is easy. Lithium ions which are likely to diffuse easily enter the inside of the secondary particles from the surface, and thus a high discharge capacity is likely to be obtained.

### [Measurement Method of α]

The element M1 and the element M2 are present on the surface of the secondary particles of the CAM. Therefore, in a case where the CAM is subjected to X-ray photoelectron spectroscopy (XPS) analysis, photoelectrons corresponding to binding energies of the element M1 and the element M2 are detected. The atomic concentrations of the element M1 and the element M2 on the surface of the secondary particles are determined by the analysis results using the XPS. Specifically, the XPS analysis of the CAM is performed under the following conditions, and a peak corresponding to each element is identified from the obtained narrow scan spectrum of the CAM. After the charge correction is carried out by setting a peak derived from a C—C bond of C1s to 286.4 eV, the peak is identified.
Measurement method: X-ray photoelectron spectroscopy (XPS)
X-ray source: AlKα ray (1486.6 eV)
X-ray spot diameter: 100 μm
Pass Energy: 112 eV
Step: 0.1 eV
Dwell time: 50 ms
Neutralization conditions: neutralization electron gun (acceleration voltage is adjusted depending on the element; current: 100 μA)

As an X-ray photoelectron spectrometer, for example, PHI 5000 VersaProbe III manufactured by ULVAC-PHI, Inc. can be used.

A detection depth of the XPS under the above-described conditions is in a range of approximately 10 nm in a depth direction from the surface of the CAM toward the center of the particles.

The peak corresponding to each element can be identified using an existing database.

As a photoelectron intensity of Nb as element M1, an integrated value of a waveform of Nb3d is used.

As a photoelectron intensity of Ta as element M1, an integrated value of a waveform of Ta4f is used.

As a photoelectron intensity of Mo as element M1, an integrated value of a waveform of Mo3d is used.

As a photoelectron intensity of B as element M1, an integrated value of a waveform of B1s is used.

As a photoelectron intensity of P as element M1, an integrated value of a waveform of P2p is used.

As a photoelectron intensity of W as element M1, an integrated value of a waveform of W4f or W4d is used.

As a photoelectron intensity of La as element M1, an integrated value of a waveform of La3d is used.

As a photoelectron intensity of Ni as element M2, an integrated value of a waveform of Ni2p3/2 is used.

As a photoelectron intensity of Co as element M2, an integrated value of a waveform of Co2p3/2 is used.

As a photoelectron intensity of Mn as element M2, an integrated value of a waveform of Mn2p1/2 is used.

As a photoelectron intensity of Li, an integrated value of a waveform of Li1s is used.

As a photoelectron intensity of O, an integrated value of a waveform of O1s is used.

In a case where the element peak overlaps with the peak of another element, the atomic concentration of the corresponding element is calculated by using a separate orbit peak.

The atomic concentrations of the element M1, the element M2, and Li are determined as follows. First, an equivalent number of atoms of each element is obtained by combining the integrated value of the photoelectron peak of each element with the device-specific sensitivity coefficient. Thereafter, the atomic concentration is calculated by combining the equivalent number of atoms. In a case where the CAM has a plurality of the elements M1 or the elements M2, the atomic concentration of the element M1 or the atomic concentration of the element M2 is a total value of the atomic concentrations of the respective elements M1 or the atomic concentrations of the respective elements M2.

The atomic concentration (atomic %) of the element M1 is calculated according to the following expression.

$$Atomic concentration of element M 1 = ( Equivalent number of atoms of element M 1 / ( Equivalent number of atoms of element M 2 + Equivalent number of atoms of element M 1 + Equivalent number of atoms of Li + Equivalent number of atoms of O ) )$$

The atomic concentration (atomic %) of the element M2 is calculated according to the following expression.

$$Atomic concentration of element M 2 = ( Equivalent number of atoms of element M 2 / ( Equivalent number of atoms of element M 2 + Equivalent number of atoms of element M 1 + Equivalent number of atoms of Li + Equivalent number of atoms of O ) )$$

The atomic concentration (atomic %) of Li is calculated according to the following expression.

$$Atomic concentration of Li = ( Equivalent number of atoms of Li / ( Equivalent number of atoms of element M 2 + Equivalent number of atoms of element M 1 + Equivalent number of atoms of Li + Equivalent number of atoms of O ) )$$

α is calculated from the calculated atomic concentrations of the element M1 and the element M2.

(2)

In the CAM according to the present embodiment, β defined below is 0.08 to 0.20.

β is a ratio of an atomic concentration (atomic %) of the element M1 present inside the secondary particles to the total amount (element M1+element M2) of the atomic concentration (atomic %) of the element M1 and the atomic concentration (atomic %) of the element M2 present inside the secondary particles. That is, β is an atomic concentration ratio “Element M1/(Element M1+Element M2)” inside the secondary particles.

β is preferably 0.08 or more, and more preferably 0.09 or more. In addition, β is preferably 0.18 or less, and more preferably 0.15 or less.

The above-described upper limit value and lower limit value thereof can be randomly combined. In the present embodiment, β is preferably 0.08 to 0.18 and more preferably 0.09 to 0.15.

In a case where β of the CAM is the above-described lower limit value or more, this means that a compound containing the element M1 and having excellent lithium ion conductivity is appropriately present inside the secondary particles. In this case, during the charging and discharging reaction, lithium ions can move from the surface of the CAM to the inside of the CAM through the compound containing the element M1 and having excellent lithium ion conductivity present inside the secondary particles of the CAM, and the charging and discharging reaction is likely to proceed smoothly, and thus the discharge capacity of the lithium ion battery can be increased.

In addition, in a case where β is the above-described upper limit value or less, this means that a proportion of the ions of the element M2 being continuously linked to each other inside the secondary particles of the CAM is high. The ions of the element M2 undergo a change in valence during the charging and discharging reaction inside the secondary particles of the CAM. In a case where the ions of the element M2 are continuously linked to each other, electrons can move through the ions of the element M2 capable of changing the valence, and the discharge capacity of the lithium ion battery can be increased.

### [Measurement Method of β]

In the CAM according to the present embodiment, the element M1 and the element M2 are also present inside the secondary particles of the CAM. Therefore, in the XPS analysis of the CAM subjected to the following Ar ion sputter treatment, photoelectrons corresponding to binding energies of the element M1 and the element M2 inside the secondary particles are detected.

In the present specification, the “inside of the secondary particles of the CAM” refers to an exposed region obtained by subjecting the secondary particles in the CAM to an Ar ion sputtering treatment under the same conditions as the conditions under which an SiO₂ film is sputtered to a depth of 100 nm by an XPS internal device. An etching rate is, for example, approximately 25 nm/min in the SiO₂ film.

For the inside of the secondary particles of the CAM exposed by the above-described Ar ion sputter treatment, the same XPS analysis and the calculation of the atomic concentration of each element as in the [Measurement method of α] are performed. As a result, the atomic concentration of the element M2 present inside the secondary particles and the atomic concentration of the element M1 present inside the secondary particles are obtained. By calculating a ratio thereof, β can be obtained.

(3)

In the CAM according to the present embodiment, it is preferable that S_{Li} defined below satisfy 1 to 4.

S_{Li} is a ratio of an atomic concentration of Li present on the surface of the secondary particles to the atomic concentration of the element M1 present on the surface of the secondary particles, which are obtained by the above-described XPS analysis. That is, S_{Li} is an atomic concentration ratio “Li/Element M1” on the surface of the secondary particles.

S_{Li} is more preferably 1.2 or more, still more preferably 1.4 or more, and particularly preferably 1.6 or more. In addition, S_{Li} is more preferably 3.8 or less, still more preferably 3.6 or less, and particularly preferably 3.4 or less.

The above-described upper limit value and lower limit value of S_{Li} can be randomly combined.

As the combination, S_{Li} is 1.2 to 3.8, 1.4 to 3.6, or 1.6 to 3.4.

In a case where S_{Li} is the above-described lower limit value or more, a CAM having excellent lithium ion conductivity and a high discharge capacity is easily obtained.

In addition, in a case where S_{Li} is the above-described upper limit value or less, a CAM having a small amount of surface residues such as lithium carbonate and lithium hydroxide is likely to be obtained, and as a result, the discharge capacity is likely to be high.

S_{Li} can be calculated from the atomic concentration of the element M1 and the atomic concentration of Li, which are calculated in the same procedure as in the section of [Measurement method of α] described above.

(4)

In the CAM according to the present embodiment, it is preferable that I_{Li} defined below satisfy 10 to 50.

I_{Li} is a ratio of an atomic concentration of Li present inside the secondary particles to the atomic concentration of the element M1 present inside the secondary particles, which are obtained by the above-described XPS analysis. That is, I_{Li} is an atomic concentration ratio “Li/Element M1” inside the secondary particles.

I_{Li} is more preferably 12 or more, and still more preferably 14 or more. In addition, I_{Li} is more preferably 45 or less, and still more preferably 40 or less.

The above-described upper limit value and lower limit value of I_{Li} can be randomly combined.

As the combination, I_{Li} is 12 to 45 or 14 to 40.

In a case where I_{Li} is the above-described lower limit value or more, the inside of the secondary particles is rich in Li, and thus a CAM having excellent lithium ion conductivity and a high discharge capacity is easily obtained.

In addition, in a case where I_{Li} is the above-described upper limit value or less, this means that the element M1 assisting lithium ion conduction is sufficiently present, and thus a CAM having excellent lithium ion conductivity and a high discharge capacity is easily obtained.

I_{Li} can be calculated from the atomic concentration of the element M1 and the atomic concentration of Li, which are calculated in the same procedure as in the section of [Measurement method of β] described above.

### <<Concentration Portion>>

It is preferable that, in the CAM according to the present embodiment, a concentration portion of the element M1 be provided at a grain boundary of the primary particles in a cross section of the secondary particles, observed by transmission electron microscope-energy dispersive X-ray spectroscopy.

The expression “concentration portion of the element M1 is provided at a grain boundary of the primary particles” means that a portion where the element M1 is concentrated is present on the surface of the primary particles or in a gap between the primary particles. In a case where the concentration portion is present on the surface of the primary particles, the element M1 may be present in a form of a solid solution on the surface of the primary particles.

In a case where the concentration portion is present in the gap between the primary particles, a compound containing the element M1 may be present at the grain boundary between the primary particles.

The cross section of the secondary particles can be acquired by the following method.

### [Method for Acquiring Cross Section]

In the present specification, the “cross section” of the secondary particles means an exposed region in a case where the CAM is processed into a thin piece by a focused ion beam (FIB).

### [Method for Confirming Concentration Portion]

The grain boundary and the concentration portion can be confirmed by, for example, a method of transmission electron microscope (TEM)—energy dispersive X-ray spectroscopy (EDX).

Specifically, the cross section obtained by the [Method for acquiring cross section] described is observed with a TEM at an appropriate magnification. In the obtained TEM observation image, for example, for adjacent primary particle A and primary particle B, the surface analysis is continuously performed from the inside of the primary particle A to the inside of the primary particle B by EDX, and E₁, which is a concentration ratio of the element M1 to the element M2, is obtained.

Subsequently, E₂, which is a ratio of the element M1 to the element M2 in a case where the surface of the region inside the primary particle, that is, the region not passing through the grain boundary is analyzed by EDX, is obtained. A portion where the E₁/E₂ ratio is more than 1 is regarded as a portion where the concentration portion is present. A portion where the E₁/E₂ ratio is less than 1 is regarded as a portion where the concentration portion is not present.

Since the concentration portion of the element M1 is present at the grain boundary of the primary particles constituting the secondary particles, extraction and insertion of the lithium ions smoothly proceed along the concentration portion. In this case, an utilization rate of the CAM in a cathode is improved, the resistance is easily reduced, and the discharge capacity is improved.

As the transmission electron microscope, for example, JEM-2100F manufactured by JEOL Ltd. can be used. As the EDX, Centurio manufactured by JEOL Ltd. can be used.

### <<BET Specific Surface Area>>

A BET specific surface area of the CAM is preferably 0.2 to 2 m²/g. The BET specific surface area is more preferably 0.3 m²/g or more, and still more preferably 0.4 m²/g or more. In addition, the BET specific surface area is more preferably 1.8 m²/g or less, and more preferably 1.5 m²/g or less.

The above-described upper limit value and lower limit value of the BET specific surface area can be randomly combined.

As the combination, the BET specific surface area is 0.3 to 1.8 m²/g or 0.4 to 1.5 m²/g.

In a case where CAM having a BET specific surface area equal to or more than the above-described lower limit value is used, a reaction interface of the CAM increases, and the lithium ions easily enter and exit, and thus the discharge capacity is likely to be high.

In a case where CAM having a BET specific surface area equal to or less than the above-described upper limit value is used, a contact area between the CAM and the electrolytic solution is not likely to increase, and a coating film due to decomposition of the electrolytic solution is not likely to be formed. In a case where such a coating film is small, the lithium ion conductivity is less likely to be inhibited, and thus the discharge capacity is likely to be high.

### [Measurement of BET Specific Surface Area]

The BET specific surface area of the CAM can be measured with a BET specific surface area measuring device.

As the BET specific surface area measuring device, for example, Macsorb (registered trademark) manufactured by Mountech Co., Ltd. can be used. In the case of measuring powdery CAM, the CAM is preferably dried at 105° C. for 30 minutes in a nitrogen atmosphere as a pretreatment.

<<D₁₀, D₉₀, and D_{50>>}

In the CAM, it is preferable that D₁₀, D₉₀, and D₅₀ satisfy the following (II).

$$( {D}_{90} - {D}_{10} ) / {D}_{50} \leq 1. \qquad ( II )$$

(in (II), D₁₀ is a 10% cumulative volume particle size of the CAM, D₅₀ is a 50% cumulative volume particle size of the CAM, and D₉₀ is a 90% cumulative volume particle size of the CAM)

D₁₀, D₉₀, and D₅₀ are preferably (II)-1 and more preferably (II)-2.

$$0.2 \leq ( {D}_{90} - {D}_{10} ) / {D}_{50} \leq 0.8 \qquad ( II ) - 1$$

$$0.2 \leq ( {D}_{90} - {D}_{10} ) / {D}_{50} \leq 0.6 \qquad ( II ) - 2$$

With the CAM satisfying (II), filling is easy in a case of producing a cathode, and the contact with the conductive auxiliary agent is favorable, and thus the discharge capacity is likely to be improved.

[Measurement of D₁₀, D₉₀, and D₅₀]

In the present specification, D₁₀ (μm), D₅₀ (μm), and D₉₀ (μm) of the CAM can be measured by the following dry method.

Specifically, first, a dry particle size distribution is measured with a laser diffraction particle size distribution analyzer using 2 g of the CAM to obtain a volume-based cumulative particle size distribution curve. In the obtained cumulative particle size distribution curve, values of particle diameters at 10%, 50%, and 90% cumulative from a fine small particle side are D₁₀, D₅₀, and D₉₀.

As the laser diffraction particle size distribution analyzer, for example, MS2000 manufactured by Malvern Panalytical Ltd. can be used.

In the CAM according to the present embodiment, a content of Mn with respect to 1 mol of the total amount of the element M2 is preferably 0.03 mol or more, and preferably 0.03 to 0.7 mol.

In a case where the proportion of Mn is the above-described lower limit value or more, a lithium secondary battery having high thermal stability is obtained.

The CAM is preferably represented by the following compositional formula (I).

$${Li}_{x} ( {Ni}_{a} {Co}_{b} {Mn}_{c} {Z}_{d} M {1}_{e} ) {O}_{δ} \qquad ( I )$$

(in the compositional formula (I), 0.98≤x≤1.80, 0.3<a≤1, 0≤b≤0.3, 0.03≤c≤0.7, 0≤d≤0.05, 0<e≤0.05, a+b+c+d+e=1, and 2≤δ<3 are satisfied, Z is at least one element selected from the group consisting of Al, Zr, and Ti, and M1 is at least one element selected from the group consisting of Nb, W, Mo, Ta, La, B, and P)

It is preferable that x satisfy 1.00<x≤1.60. In addition, from the viewpoint of obtaining a lithium secondary battery having high cycle characteristics, x in the compositional formula (I) is more preferably 1.01 or more, and still more preferably 1.03 or more. In addition, from the viewpoint of suppressing the formation of the resistance layer, x in the compositional formula (I) is more preferably 1.50 or less, and still more preferably 1.30 or less.

The upper limit value and lower limit value of x can be randomly combined.

As the combination, x is 1.01 to 1.50 or 1.03 to 1.30.

In addition, from the viewpoint of obtaining a lithium ion secondary battery having high battery capacity, a in the compositional formula (I) is preferably more than 0.40, more preferably 0.45 or more, still more preferably 0.50 or more, and particularly preferably 0.55 or more. In addition, from the viewpoint of obtaining a lithium secondary battery having high thermal stability, a in the compositional formula (I) is more preferably 0.98 or less, still more preferably 0.95 or less, and even more preferably 0.90 or less.

The upper limit value and lower limit value of a can be randomly combined. In the compositional formula (II), a may be 0.45 to 0.98, 0.50 to 0.95, or 0.55 to 0.90.

It is preferable that b satisfy 0≤b≤0.25. In addition, from the viewpoint of obtaining a lithium secondary battery having high cycle characteristics, b in the compositional formula (I) is more preferably more than 0, and still more preferably more than 0 and 0.25 or less.

From the viewpoint of obtaining a lithium secondary battery having high cycle characteristics, c in the compositional formula (I) is preferably 0.05 or more, more preferably 0.10 or more, still more preferably 0.20 or more, and particularly preferably 0.25 or more. In addition, from the viewpoint of obtaining a lithium secondary battery having high storage stability at a high temperature (for example, under an environment of 60° C.), c in the compositional formula (I) is preferably 0.50 or less, more preferably 0.40 or less, and still more preferably 0.30 or less.

The upper limit value and lower limit value of c can be randomly combined. In the compositional formula (II), c may be 0.05 to 0.50, 0.20 to 0.40, or 0.25 to 0.30.

It is preferable that c satisfy 0.05≤c≤0.50.

It is preferable that d satisfy 0≤d≤0.03.

It is preferable that e satisfy 0<e≤0.03.

### [Composition Analysis]

A composition (the compositional formula (I) and the content of Mn) of the CAM can be analyzed using an inductively coupled plasma emission spectrometer (for example, SPS3000 manufactured by Seiko Instruments Inc.) after the CAM is dissolved in hydrochloric acid.

### (Crystal Structure)

In the present specification, the “layered structure” means a hexagonal crystal structure or a monoclinic crystal structure.

The hexagonal crystal structure belongs to any one space group selected from the group consisting of P3, P3₁, P3₂, R3, P-3, R-3, P312, P321, P3₁12, P3₁21, P3₂12, P3₂21, R32, P3m1, P31m, P3c1, P31c, R3m, R3c, P-31m, P-31c, P-3m1, P-3c1, R-3m, R-3c, P6, P6₁, P6₅, P6₂, P6₄, P6₃, P-6, P6/m, P6₃/m, P622, P6₁22, P6₅22, P6₂22, P6₄22, P6₃22, P6 mm, P6cc, P6₃ cm, P6₃mc, P-6m2, P-6c2, P-62m, P-62c, P6/mmm, P6/mcc, P6₃/mcm, and P6₃/mmc.

In addition, the monoclinic crystal structure belongs to any one space group selected from the group consisting of P2, P21, C2, Pm, Pc, Cm, Cc, P2/m, P2₁/m, C2/m, P2/c, P2₁/c, and C2/c.

Among the above, in order to obtain a lithium secondary battery having a high discharge capacity, the crystal structure is preferably any one or both of a hexagonal crystal structure belonging to the space group R-3m and a monoclinic crystal structure belonging to the space group C2/m.

### [Method for Confirming Layered Structure]

Whether or not the CAM has a layered structure can be confirmed by observing the crystal structure thereof using a powder X-ray diffractometer (for example, Ultima IV manufactured by Rigaku Corporation).

It is preferable that a compound containing the above-described element M1 and Li be present on the surface of the secondary particles of the CAM. Specifically, lithium niobate, lithium tantalate, lithium-lanthanum zirconate oxide, lithium-lanthanum titanate oxide, lithium tungstate, lithium phosphate, and lithium borate are exemplary examples.

### [Measurement of Initial Discharge Capacity]

In the present embodiment, an initial discharge capacity using the CAM can be measured by the following method.

A method of evaluating the initial discharge capacity will be described using a solid state lithium ion battery as an example.

### <Manufacturing of Solid Lithium Ion Secondary Battery>

The following operation is carried out in a glove box under an argon atmosphere.

### (Production of Cathode Mixture)

1,000 g of the CAM, 0.0543 g of a conductive material (Acetylene Black), and 8.6 mg of a solid electrolyte (manufactured by MSE CO., LTD., Li₆PS₅Cl) are weighed. The CAM, the conductive material, and the solid electrolyte were mixed in a mortar for 15 minutes to produce a cathode mixture powder.

### (Battery Production)

160 mg of a solid electrolyte powder is put in a polyethylene terephthalate tube (PET tube, inner diameter: 10 mm) into which an SUS rod (diameter: 10 mm) is inserted from above, and the solid electrolyte powder is pressed at 10 MPa to form a solid electrolyte layer having a diameter of 10 mm. Thereafter, the SUS rod inserted from above is taken out, 15 mg of the above-described cathode mixture powder is put on the solid electrolyte layer, an SUS plate (diameter: 10 mm) as a current collector is placed thereon, and then the SUS rod is inserted. Furthermore, an indium foil and a lithium metal foil are placed on the solid electrolyte layer opposite to the cathode mixture powder, uniaxially pressed at 14 MPa, and constrained at 6 MPa to produce a solid lithium ion battery.

### <Charging and Discharging Test>

Using the solid lithium ion battery produced by the above-described method, a charging and discharging test was carried out under the following conditions.

### (Charging and Discharging Conditions)

Test temperature: 60° C.

### (Charging and Discharging)

Charging maximum voltage: 3.68 V; Charging current density: 0.1 C, Cutoff current density: 0.02 C; Constant current-constant voltage charging
Discharging minimum voltage: 1.88 V; Discharging current density: 0.1 C; Constant current discharging

In a case where the initial discharge capacity measured by the above-described method was 172 mAh/g or more, it was evaluated that “discharge capacity is high”.

### <Method for Manufacturing CAM>

A method for manufacturing the CAM according to the present embodiment includes a step of introducing a coating material raw material containing the element M1 twice or more. Specifically, the manufacturing method includes a manufacturing step (A) or a manufacturing step (B) described later, and a step of mixing the obtained sintered product with the coating material raw material containing the element M1.

In manufacturing the CAM, it is preferable that, first, an MCC containing at least one element M2 selected from the group consisting of Ni, Co, and Mn be prepared, and the MCC be sintered with an appropriate lithium compound. As the MCC, a metal composite hydroxide or a metal composite oxide is preferable.

Hereinafter, an example of a method for manufacturing the CAM will be described by dividing the method into a step of manufacturing the MCC and a step of manufacturing the CAM.

### (Step of Manufacturing MCC)

The MCC can be manufactured by a generally known co-precipitation method. As the co-precipitation method, it is possible to use a commonly known batch co-precipitation method or a continuous co-precipitation method. Hereinafter, the method for manufacturing the MCC will be described in detail using a metal composite hydroxide containing Ni, Co, and Mn as an example.

First, a nickel salt solution, a cobalt salt solution, a manganese salt solution, and a complexing agent are reacted with one another by a co-precipitation method, particularly, a continuous co-precipitation method described in JP-A-2002-201028, thereby manufacturing a metal composite hydroxide represented by NiₐCo_{b}Mn_{c} (OH)₂ (in the formula, 0<a+b+c≤1).

A nickel salt solute of the above-described nickel salt solution is not particularly limited, and, for example, one or two or more of nickel sulfate, nickel nitrate, nickel chloride, and nickel acetate can be used.

As a cobalt salt solute of the above-described cobalt salt solution, for example, one or two or more of cobalt sulfate, cobalt nitrate, cobalt chloride, and cobalt acetate can be used.

As a manganese salt which is a solute of the above-described manganese salt solution, for example, one or two or more of manganese sulfate, manganese nitrate, manganese chloride, and manganese acetate can be used.

The above-described metal salt is used in a proportion corresponding to the compositional ratio of NiₐCo_{b}Mn_{c}(OH)₂. That is, the amount of each of the metal salts used is set so that the molar ratio of Ni in the solute of the nickel salt solution, Co in the solute of the cobalt salt solution, and Mn in the solute of the manganese salt solution is to be a:b:c corresponding to the compositional ratio of NiₐCo_{b}Mn_{c} (OH)₂.

In addition, solvents of the nickel salt solution, the cobalt salt solution, and the manganese salt solution are water. That is, the solvent of the nickel salt solution, the cobalt salt solution, and the manganese salt solution is an aqueous solution.

The complexing agent is a compound capable of forming a complex with a nickel ion, a cobalt ion, and a manganese ion in an aqueous solution. As the complexing agent, for example, ammonium ion donors (ammonium salts such as ammonium hydroxide, ammonium sulfate, ammonium chloride, ammonium carbonate, and ammonium fluoride), hydrazine, ethylenediaminetetraacetic acid, nitrilotriacetic acid, uracildiacetic acid, and glycine are exemplary examples.

In a case of using the complexing agent, the amount of the complexing agent contained in the mixed solution containing the nickel salt solution, the optional metal salt solution, and the complexing agent is, for example, a molar ratio of more than 0 and 2.0 or less with respect to the total number of moles of the metal salt. In a case of using the complexing agent, the amount of the complexing agent contained in the mixed solution containing the nickel salt solution, the cobalt salt solution, the manganese salt solution, and the complexing agent is, for example, a molar ratio of more than 0 and 2.0 or less with respect to the total number of moles of the metal salt.

In the co-precipitation method, in order to adjust the pH value of the mixed solution containing the nickel salt solution, the optional metal salt solution, and the complexing agent, an alkali metal hydroxide is added to the mixed solution before the pH of the mixed solution changes from alkaline to neutral. The alkali metal hydroxide is, for example, sodium hydroxide or potassium hydroxide.

The value of pH in the present specification is defined as a value measured in a case where the temperature of the mixed solution is 40° C. The pH of the mixed solution is measured in a case where the temperature of the mixed solution sampled from a reaction vessel reaches 40° C.

In a case where the complexing agent in addition to the nickel salt solution, the cobalt salt solution, and the manganese salt solution described above is continuously supplied to the reaction vessel, Ni, Co, and Mn react with each other to form NiₐCo_{b}Mn_{c} (OH)₂.

During the reaction, the temperature of the reaction vessel is controlled, for example, within a range of 20° C. to 80° C., preferably 30° C. to 70° C.

In addition, during the reaction, the pH value in the reaction vessel is controlled, for example, within a range of pH 9 to 13, preferably pH 11 to 13.

The substances in the reaction vessel are appropriately stirred and mixed together.

As the reaction vessel which is used in the continuous co-precipitation method, an overflow type reaction vessel can be used to separate the formed reaction precipitate.

In addition to the control of the above-described conditions, a variety of gases, for example, an inert gas such as nitrogen, argon, or carbon dioxide, an oxidizing gas such as an air or oxygen, or a gas mixture thereof may be supplied to the reaction vessel.

In detail, the inside of the reaction vessel may be an inert atmosphere. In a case where the inside of the reaction vessel is an inert atmosphere, an element which is more easily oxidized than Ni contained in the mixed solution is prevented from aggregating earlier than Ni. Therefore, a uniform metal composite hydroxide can be obtained.

After the above-described reaction, the obtained reaction precipitate is washed with water and dried, whereby the MCC is obtained. In the present embodiment, a nickel cobalt manganese hydroxide is obtained as the MCC. In addition, in a case where the reaction precipitate is washed with water only, and foreign matter derived from the mixed solution remains, the reaction precipitate may be washed with weak acid water or an alkaline solution, as necessary. As the alkaline solution, an aqueous solution containing sodium hydroxide or potassium hydroxide is an exemplary example.

In the above-described example, the nickel-cobalt-manganese composite hydroxide is manufactured, but a nickel-cobalt-manganese composite oxide may be prepared.

In a case of manufacturing the MCC which is a metal composite oxide, a metal composite oxide can be manufactured by oxidizing the metal composite hydroxide. For example, the nickel-cobalt-manganese composite oxide can be prepared by oxidizing the nickel-cobalt-manganese composite hydroxide. In a case of adjusting the metal composite oxide, the metal composite hydroxide may be oxidized at a temperature of 300° C. to 800° C. for a period of time of 1 to 30 hours.

A temperature rising rate during the oxidation is preferably 180° C./hour or more, more preferably 200° C./hour or more, and particularly preferably 250° C./hour or more.

In addition, the inside of the reaction vessel may be an appropriate oxidizing atmosphere. The oxidizing atmosphere may be an oxygen-containing atmosphere formed by mixing an oxidizing gas into an inert gas, and when the inside of the reaction vessel, in which an oxidizing agent may be present in an inert gas atmosphere, is an appropriate oxidizing atmosphere, which makes it easy to control the form of the metal composite oxide.

As oxygen or the oxidizing agent in the oxidizing atmosphere, a sufficient number of oxygen atoms need to be present in order to oxidize the transition metal element.

As the oxidizing agent, a peroxide such as hydrogen peroxide, a peroxide salt such as permanganate, perchloric acid, hypochlorous acid, nitric acid, halogen, ozone, or the like can be used.

In a case where the oxidizing atmosphere is an oxygen-containing atmosphere, the atmosphere in the reaction vessel can be controlled by a method in which an oxidizing gas is bubbled or the like in the liquid mixture which aerates the oxidizing gas into the reaction vessel.

### (CAM Manufacturing Step)

The CAM according to the present embodiment can be obtained by a manufacturing method including the following manufacturing step (A) or manufacturing step (B) and a step of mixing the obtained sintered product with the coating material raw material containing the element M1.

Manufacturing step (A): a step of obtaining a mixture containing the MCC, the coating material raw material containing the element M1, and a lithium compound, and a step of sintering the mixture to obtain a sintered product

Manufacturing step (B): a step of obtaining a primary sintered product by subjecting a mixture of the MCC and a lithium compound to primary sintering, and a step of obtaining a sintered product by mixing the primary sintered product with the coating material raw material containing the element M1 and subjecting the mixture to main firing.

One aspect of the manufacturing step of the CAM includes the manufacturing step (A) and a step of mixing the obtained sintered product with the coating material raw material containing the element M1.

One aspect of the manufacturing step of the CAM includes the manufacturing step (B) and a step of mixing the obtained sintered product with the coating material raw material containing the element M1.

### [Manufacturing Step (A)]

### (Step of Mixture Containing MCC, Coating Material Raw Material Containing Element M1, and Lithium Compound)

First, the MCC, the coating material raw material containing the element M1, and the lithium compound are mixed to obtain a mixture containing the MCC, the coating material raw material containing the element M1, and the lithium compound. For example, a method in which the coating material raw material is added to and mixed with the MCC, and then the lithium compound is mixed therewith to obtain a mixture is an exemplary example.

The method of mixing the MCC and the coating material raw material may be any of a dry method or a wet method, but a wet method is preferable. In a case where the mixing of the MCC and the coating material raw material is carried out by a wet method, a drying step may be further carried out. In a case where the MCC and the coating material raw material are mixed by a wet method, the concentration portion of M1 is likely to be formed at the grain boundary of the primary particles inside the secondary particles.

In a case where the wet method is used, dispersibility of the coating material raw material inside the secondary particles of the CAM can be increased, and aggregation of the coating material raw material can be prevented. In the wet method, the above-described effects can be enhanced by carrying out the mixing, stirring, and drying of the MCC and the coating material raw material in the same step.

The coating material raw material is a material containing at least one element M1 selected from the group consisting of Nb, Ta, B, Mo, W, La, and P.

In a case of carrying out the wet method, the coating material raw material is preferably an additive solution containing a Li source, an element M1 source, and a solvent. As the element M1 source, an oxide, a hydroxide, a carbonate, a nitrate, a sulfate, a halide, an oxalate, an alkoxide, and a complex of the element M1 are exemplary examples.

As the Li source, for example, Li alkoxide, Li inorganic salt, and Li hydroxide are exemplary examples.

As the Li alkoxide, for example, ethoxy lithium and methoxy lithium are exemplary examples.

As the Li inorganic salt, for example, lithium nitrate, lithium sulfate, and lithium acetate are exemplary examples. As the Li hydroxide, for example, lithium hydroxide and lithium hydroxide hydrate are exemplary example.

In a case where the element M1 is Nb, as an Nb source, for example, Nb alkoxide, Nb inorganic salt, Nb hydroxide, and Nb complex are exemplary examples.

As the Nb alkoxide, for example, pentaethoxy niobium, pentamethoxy niobium, penta-i-propoxy niobium, penta-n-propoxy niobium, penta-i-butoxy niobium, penta-n-butoxy niobium, and penta-sec-butoxy niobium are exemplary examples.

As the Nb inorganic salt, for example, niobium acetate and the like are exemplary examples. A hydrate may be used as the niobium oxide.

As the Nb hydroxide, for example, niobium hydroxide is an exemplary example.

As the Nb complex, for example, a peroxo complex of Nb (peroxoniobate complex [Nb(O₂)₄]³⁻) is an exemplary example.

The additive solution containing the peroxo complex of Nb has an advantage that the amount of gas generated is smaller than that in the additive solution containing the Nb alkoxide.

As a method for preparing the additive solution containing the peroxo complex of Nb, for example, a method of adding hydrogen peroxide water and ammonia water to an Nb oxide or an Nb hydroxide is an exemplary example. Addition amounts of the hydrogen peroxide water and the ammonia water may be appropriately adjusted so that a transparent solution (uniform solution) is obtained.

In a case where the element M1 is Ta, as a Ta source, tantalum oxide is an exemplary example.

In a case where the element M1 is B, as a B source, boron oxide is an exemplary example.

In a case where the element M1 is Mo, as an Mo source molybdenum oxide is an exemplary example.

In a case where the element M1 is W, as a W source, tungsten oxide and lithium tungstate are exemplary examples.

In a case where the element M1 is La, as an La source, lanthanum oxide is an exemplary example.

In a case where the element M1 is P, as a P source, ammonium dihydrogenphosphate and diammonium hydrogenphosphate are exemplary examples.

The type of the solvent in the additive solution is not particularly limited, and alcohol, water, and the like are exemplary examples.

As the alcohol, for example, methanol, ethanol, propanol, butanol, and the like are exemplary examples. In a case where the additive solution contains the Nb alkoxide, the solvent is preferably anhydrous alcohol or dewatered alcohol. On the other hand, for example, in a case where the additive solution contains the peroxo complex of Nb, the solvent preferably is water.

In a case where the MCC and the coating material raw material are mixed, a mixing device is not limited as long as the mixing can be uniformly performed. For example, it is preferable to perform the mixing using a Lodige mixer or a rolling fluidity device. These devices can spray-mix the coating material raw material while flowing the MCC, and can stir and dry the coating material raw material. As the rolling fluidity device, for example, MP-01 manufactured by Powrex corp. can be suitably used.

The MCC and the coating material raw material are used at a proportion corresponding to the compositional ratio of the compositional formula (I) described above.

As the lithium compound, it is possible to use any one of lithium carbonate, lithium nitrate, lithium acetate, lithium hydroxide, lithium oxide, lithium chloride, and lithium fluoride, or a mixture of two or more thereof. Among these, any one or both of lithium hydroxide and lithium carbonate are preferable.

The lithium compound and the MCC are used in consideration of the compositional ratio of the final target product. The lithium compound and the MCC are used at a proportion corresponding to the compositional ratio of the compositional formula (I) described above. In addition, in a case where Li is excessive (the content molar ratio is more than 1) in the CAM, which is the final target product, the lithium compound and the MCC are mixed at a proportion of a molar ratio of Li contained in the lithium compound to the metal element contained in the MCC being more than 1.

As a result, the values of S_{Li} and I_{Li} can be controlled within the ranges of the present embodiment.

### (Step of Sintering Mixture to Obtain Sintered Product)

Next, the mixture containing the MCC, the coating material raw material, and the lithium compound is sintered to obtain a sintered product.

By sintering the above-described mixture, the MCC and the lithium compound react with each other to grow primary particles, and the primary particles are aggregated and sintered with each other to form secondary particles having grain boundaries. The element M1 is present at the grain boundary of the primary particles, and the concentration portion of the element M1 is formed.

For example, the mixture of the nickel-cobalt-manganese composite compound and the lithium compound is sintered to obtain a lithium-nickel-cobalt-manganese composite oxide. In the sintering, a dry air, an oxygen atmosphere, an inert atmosphere, or the like is used depending on a desired composition.

As a holding temperature in the sintering, specifically, a range of 600° C. to 1150° C. is an exemplary example, preferably 650° C. to 1050° C. and more preferably 700° C. to 1000° C. As a time for holding at the holding temperature, 0.1 to 20 hours is an exemplary example, preferably 0.5 to 10 hours. In addition, as the sintering atmosphere, it is possible to use an air, oxygen, nitrogen, argon, or a mixed gas thereof.

The sintering may be carried out a plurality of times, and for example, a mixture containing the MCC, the coating material raw material, and the lithium compound may be subjected to primary sintering, and then may be subjected to main sintering at a temperature higher than the primary sintering. As a holding temperature and a holding time during the primary sintering and the main sintering, ranges described in [Manufacturing step (B)] later are exemplary examples.

### [Manufacturing Step (B)]

### (Step of Subjecting Mixture of MCC and Lithium Compound to Primary Sintering to Obtain Primary Sintered Product)

The MCC obtained in (Step of manufacturing MCC) is mixed with a lithium compound to obtain a mixture of the MCC and the lithium compound. As the lithium compound, the compounds mentioned in [Manufacturing step (A)] can be used. The lithium compound and the MCC are used at a proportion corresponding to the compositional ratio of the compositional formula (I) described above.

Next, the mixture of the MCC and the lithium compound is subjected to primary sintering to obtain a primary sintered product.

As a holding temperature of the primary sintering, specifically, a range of 300° C. or higher and 750° C. or lower is an exemplary example, preferably 400° C. or higher and 700° C. or lower and more preferably 450° C. or higher and 680° C. or lower.

As a time for holding at the holding temperature of the primary sintering, 0.1 hour or longer and 20 hours or shorter is an exemplary example, preferably 0.5 hours or longer and 10 hours or shorter. A temperature rising rate up to the above-described holding temperature is usually 50° C./hour or more and 400° C./hour or less, and a temperature decreasing rate from the above-described holding temperature to room temperature is usually 10° C./hour or more and 400° C./hour or less. In addition, as the primary sintering atmosphere, it is possible to use an air, oxygen, nitrogen, argon, or a mixed gas thereof.

(Step of Mixing Primary Sintered Product with Coating Material Raw Material Containing Element M1, and Performing Main Sintering to Obtain Sintered Product)

The coating material raw material containing the element M1 is mixed with the primary sintered product, and the mixture is subjected to main sintering. In this manner, a sintered product (main sintered product) is obtained.

In a case of mixing the primary sintered product and the coating material raw material, any of a dry method or a wet method may be used, but a wet method is preferable. In a case where the mixing of the primary sintered product and the coating material raw material is carried out by a wet method, a drying step may be further carried out. As the coating material raw material and the mixing device, the materials and the mixing device described in [Manufacturing step (A)] are exemplary examples.

The primary sintered product is a secondary particle having a grain boundary in which the MCC and the lithium compound react with each other, and primary particles are aggregated and sintered. By mixing the primary sintered product with the coating material raw material and performing main sintering, the element M1 diffuses to the grain boundary, and the concentration portion of the element M1 is formed.

As a holding temperature of the main sintering, specifically, a range of 600° C. or higher and 1150° C. or lower is an exemplary example, preferably 650° C. or higher and 1050° C. or lower and more preferably 700° C. or higher and 1000° C. or lower.

In addition, as a time for holding at the holding temperature of the main sintering, 0.1 hour or longer and 20 hours or shorter is an exemplary example, preferably 0.5 hours or longer and 10 hours or shorter. A temperature rising rate up to the above-described holding temperature is usually 50° C./hour or more and 400° C./hour or less, and a temperature decreasing rate from the above-described holding temperature to room temperature is usually 10° C./hour or more and 400° C./hour or less. In addition, as the main sintering atmosphere, it is possible to use an air, oxygen, nitrogen, argon, or a mixed gas thereof.

### (Arbitrary Crushing Step)

It is preferable to subject the sintered product obtained in the manufacturing step (A) or the manufacturing step (B) to a crushing treatment. By crushing the sintered product, the sintered product is crushed starting from the large pores. Therefore, the CAM in which the proportion of large pores is small is obtained.

The sintered product may be subjected to the crushing treatment, and the obtained crushed product may be further sintered. In addition, the crushed product may be dried.

By the sintering after the crushing, it is possible to remove foreign substances such as lithium carbonate, generated on the surface of the crushed product.

As a crusher used for the crushing treatment, a mass colloider-type crusher is an exemplary example.

A rotation speed of the crusher is preferably in a range of 500 to 2,000 rpm.

By the above-described steps, a sintered product (main sintered product) is obtained.

By using the sintered product obtained in the manufacturing step (A) or the manufacturing step (B), the values of β, S_{Li}, and I_{Li} of the CAM can be controlled within the above-described ranges.

### [Step of Mixing Sintered Product and Coating Material Raw Material Containing Element M1]

By mixing the sintered product (in a case where the crushing step is carried out, the crushed product) obtained by the above-described manufacturing step (A) or manufacturing step (B) with the coating material raw material containing the element M1 and carrying out a heat treatment as necessary, a coated CAM is obtained. A wet method is preferable as a method of mixing the sintered product and the coating material raw material. Specifically, the coating material raw material is sprayed onto the sintered product to mix the sintered product and the coating material raw material. As the coating material raw material and the device in the coating step, the materials and the device described in [Manufacturing step (A)] are exemplary examples. As a coating method, a wet method using a rolling fluidity device is preferable, and as the coating material raw material, a material containing Nb is preferable.

In a case where the rolling fluidity device is used in the coating step, it is preferable to use a two-fluid spray nozzle which atomizes the coating material raw material with high-pressure air in a case where the coating material raw material is added. In order to adjust α and β of the CAM to the above-described ranges, it is preferable to control a flow rate of the high-pressure air in a range of 10 to 80 NL/min.

The sintered product contains secondary particles formed by aggregating the primary particles. By setting the flow rate of the high-pressure air to be the above-described upper limit value or less, the newly formed surface inside the secondary particles is less likely to be exposed in a case where the secondary particles are crushed. The newly formed surface inside the secondary particles in which the element M1 is not present is less likely to be generated, whereby the values of α and β of the CAM can be controlled to be the lower limit values thereof or more.

On the other hand, by setting the flow rate of the high-pressure air to be the above-described lower limit value or more, a liquid droplet diameter of the coating material raw material is uniformly reduced, and the liquid droplets can be uniformly attached to the surface of the sintered product, whereby α of the CAM can be controlled to be the lower limit value or more.

In addition, by setting the flow rate of the high-pressure air to be the above-described lower limit value or more, the coating material raw material is less likely to excessively permeate into the secondary particles in the sintered product, whereby β of the CAM can be controlled to be the upper limit value or less. In addition, in a case where the flow rate of the high-pressure air is the above-described lower limit value or more, aggregation between the secondary particles can be loosened, and in a case where the flow rate of the high-pressure air is the above-described upper limit value or less, micronization due to the crushing of the secondary particles can be suppressed. As a result, (D₉₀-D₁₀)/D₅₀ and the BET specific surface area can be adjusted within the ranges of the present embodiment.

The sintered product and the coating material raw material can be mixed at a proportion corresponding to the compositional ratio of the compositional formula (I) described above.

The coating material raw material and the sintered product may be mixed and then heat-treated. Heat treatment conditions are prepared according to the type of the coating material raw material. As the heat treatment conditions, the heat treatment temperature and the holding time of the heat treatment are exemplary examples.

For example, in a case where the coating material raw material contains Nb, it is preferable to perform the heat treatment at a temperature of 200° C. or higher and 800° C. or lower for 4 hours or longer and 10 hours or shorter. In a case where the heat treatment temperature is within the above-described range, it is possible to prevent the coating material raw material from being solid-solved with the sintered product. In a case where the heat treatment time is within the above-described range, the coating material raw material can be sufficiently diffused in the sintered product.

The heat treatment temperature in the present specification means a temperature of an atmosphere in a heating furnace, and is the highest temperature of the holding temperature in the heat treatment step.

By mixing the coating material raw material and the sintered product and subjecting the mixture to the heat treatment under the above-described heat treatment conditions, the CAM can be obtained.

The CAM may be appropriately crushed and classified.

Since the element M1 is present inside or on the surface of the secondary particles of the CAM without being biased, the CAM in which α and β are within the ranges of the present embodiment can be obtained by going through the manufacturing step (A) or the manufacturing step (B) and the step of mixing the obtained sintered product with the coating material raw material containing the element M1.

### <Lithium Secondary Battery>

A cathode for lithium secondary batteries, which is suitable in a case where the CAM according to the present embodiment is used, will be described. Hereinafter, the cathode for lithium secondary batteries will be referred to as a cathode in some cases.

Furthermore, a lithium secondary battery suitable as a cathode application will be described.

An example of the lithium secondary battery suitable for a case in which the CAM according to the present embodiment is used has a cathode, an anode, a separator interposed between the cathode and the anode, and an electrolytic solution disposed between the cathode and the anode.

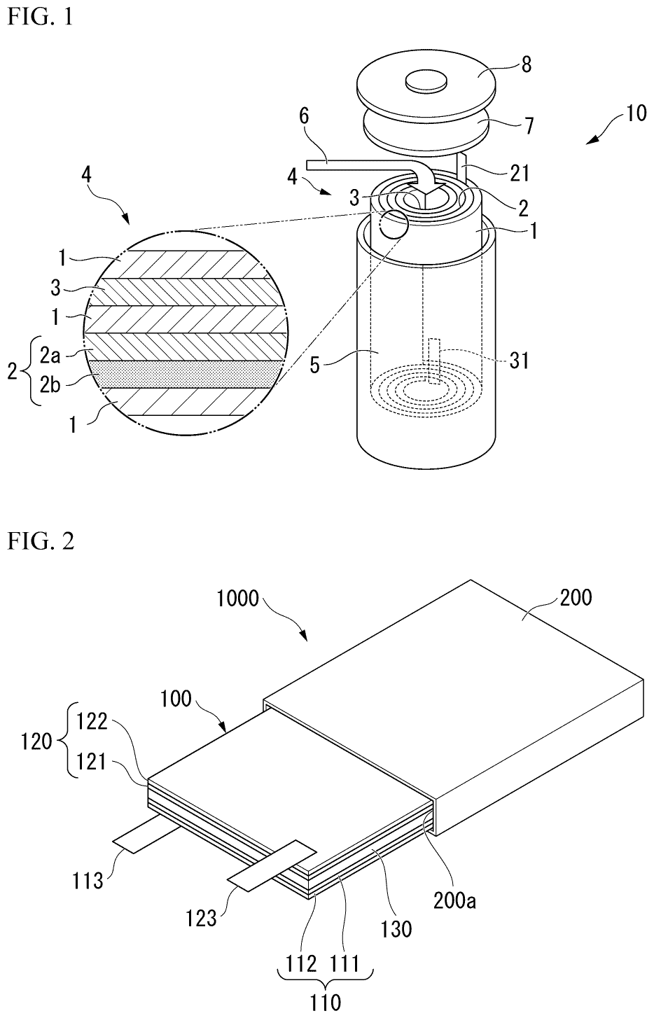

FIG. 1 is a schematic view showing an example of the lithium secondary battery. For example, a cylindrical lithium secondary battery 10 is manufactured as described below.

First, as shown in the partially enlarged view of FIG. 1, a pair of separators 1 having a strip shape, a strip-shaped cathode 2 having a cathode lead 21 at one end, and a strip-shaped anode 3 having an anode lead 31 at one end are laminated in order of the separator 1, the cathode 2, the separator 1, and the anode 3 are wound to form an electrode group 4.

The cathode 2 includes, for example, a cathode active material layer 2a containing the CAM and a cathode current collector 2b having the cathode active material layer 2a formed on one surface thereof. The cathode 2 can be produced by first preparing a cathode material mixture containing the CAM, a conductive material, and a binder, and supporting the cathode material mixture on one surface of the cathode current collector 2b to form a cathode active material layer 2a.

As an example of the anode 3, an electrode in which an anode material mixture containing an anode active material (not shown) is supported on an anode current collector, and an electrode consisting of an anode active material alone are exemplary examples, and the anode 3 can be produced in a manner similar to that for the cathode 2.

Next, the electrode group 4 and an insulator (not shown) are accommodated in a battery can 5, and a can bottom is sealed. The electrode group 4 is impregnated with an electrolytic solution 6, and an electrolyte is disposed between the cathode 2 and the anode 3. Furthermore, the upper portion of the battery can 5 is sealed with a top insulator 7 and a sealing body 8, whereby the lithium secondary battery 10 can be produced.

As a shape of the electrode group 4, for example, a columnar shape in which the cross-sectional shape is a circle, an ellipse, a rectangle, or a rectangle with rounded corners in a case where the electrode group 4 is cut in a direction perpendicular to a winding axis can be an exemplary example.

In addition, as the shape of the lithium secondary battery having such an electrode group 4, a shape that is specified by IEC60086, which is a standard for batteries specified by the International Electrotechnical Commission (IEC) or by JIS C 8500, can be adopted.

For example, shapes such as a cylindrical shape and a square shape can be exemplary examples.

Furthermore, the lithium secondary battery is not limited to the above-described winding-type configuration, and may have a lamination-type configuration of a laminated structure in which the cathode, the separator, the anode, and the separator are repeatedly stacked. As the lamination-type lithium secondary battery, a so-called coin-type battery, button-type battery, or paper-type (or sheet-type) battery can be exemplary examples.

For the cathode, the separator, the anode, and the electrolytic solution constituting the lithium secondary battery, for example, the configurations, materials, and production methods described in [0113] to [0140] of WO2022/113904A1 can be used.

### <All-Solid-State Lithium Secondary Battery>

The CAM according to the present embodiment can be used as a CAM of an all-solid-state lithium secondary battery.

FIG. 2 is a schematic view showing an example of the all-solid-state lithium secondary battery. An all-solid-state lithium secondary battery 1000 shown in FIG. 2 has a laminate 100 having a cathode 110, an anode 120, and a solid electrolyte layer 130, and an exterior body 200 accommodating the laminate 100. In addition, the all-solid-state lithium secondary battery 1000 may have a bipolar structure in which the CAM and an anode active material are disposed on both sides of a current collector. As specific examples of the bipolar structure, for example, the structures described in JP-A-2004-95400 are exemplary examples.

The cathode 110 has a cathode active material layer 111 and a cathode current collector 112.

The cathode active material layer 111 contains the above-described CAM and a solid electrolyte. In addition, the cathode active material layer 111 may contain a conductive material and a binder.

The anode 120 has an anode active material layer 121 and the anode current collector 122.

The anode active material layer 121 contains an anode active material. In addition, the anode active material layer 121 may contain a solid electrolyte and a conductive material.

The laminate 100 may have an external terminal 113 which is connected to a cathode current collector 112 and an external terminal 123 which is connected to an anode current collector 122. In addition, the all-solid-state lithium secondary battery 1000 may have a separator between the cathode 110 and the anode 120.

The all-solid-state lithium secondary battery 1000 further has an insulator (not shown) which insulates the laminate 100 and the exterior body 200 from each other and a sealant (not shown) which seals an opening portion 200a of the exterior body 200.

As the exterior body 200, a container formed of a highly corrosion-resistant metal material such as aluminum, stainless steel or nickel-plated steel can be used. In addition, as the exterior body 200, a container obtained by processing a laminate film having at least one surface on which a corrosion resistant process has been carried out into a bag shape can also be used.

As the shape of the all-solid-state lithium secondary battery 1000, for example, shapes such as a coin-type, a button type, a paper-type (or a sheet-type), a cylindrical type, a square shape, and a laminate type (pouch type) can be exemplary examples.

As the example of the all-solid-state lithium secondary battery 1000, a form in which one laminate 100 is provided is shown in the drawings, but the present embodiment is not limited thereto. The all-solid-state lithium secondary battery 1000 may have a configuration in which the laminate 100 is used as a unit cell and a plurality of unit cells (laminates 100) is sealed inside the exterior body 200.

For the all-solid-state lithium secondary battery, for example, the configurations, materials, and production methods described in [0151] to [0181] of WO2022/113904A1 can be used.

In the lithium secondary battery having the above-described configuration, since the CAM according to the present embodiment is used, it is possible to provide a lithium secondary battery capable of maintaining a discharge capacity even in a case where charging and discharging are repeated.

In addition, since the cathode having the above-described configuration has the CAM having the above-described configuration, the discharge capacity can be maintained even in a case where the charging and discharging of the lithium secondary battery are repeated.

Furthermore, since the lithium secondary battery having the above-described configuration has the above-described cathode, the lithium secondary battery is a secondary battery capable of maintaining the discharge capacity even in a case where charging and discharging are repeated.

As described above, although preferred examples of the embodiments according to the present invention have been described with reference to the accompanying drawings, the present invention is not limited to such examples. The variety of shapes, combinations, and the like of the individual constituent members described in the above-described examples are examples, and a variety of modifications are permitted based on design requirements and the like without departing from the gist of the present invention.

Furthermore, the present invention may include the following aspects.
[21] A CAM containing secondary particles which are an aggregate of primary particles,
in which the CAM has a layered structure,
the CAM contains the above-described element M1 and the above-described element M2, and
the following (1) and (2) are satisfied,
(1) the α is 0.70 to 0.96,
(2) the β is 0.08 to 0.18.
[22] The CAM according to [21],
in which a concentration portion of the element M1 is provided at a grain boundary of the primary particles in a cross section of the secondary particles, observed by transmission electron microscope-energy dispersive X-ray spectroscopy.
[23] The CAM according to [21] or [22],
in which a content of Mn with respect to 1 mol of the total amount of the element M2 is 0.03 to 0.7 mol.
[24] The CAM according to any one of [21] to [23],
in which the CAM is represented by the above-described compositional formula (I).
[25] The CAM according to any one of [21] to [24],
in which the S_{Li} is 1.6 to 3.4.
[26] The CAM according to any one of [21] to [25],
in which the I_{Li} is 14 to 40.
[27] The CAM according to any one of [21] to [26],
in which the BET specific surface area is 0.4 to 1.5 m²/g.
[28] The CAM according to any one of [21] to [27],
in which D₁₀, D₅₀, and D₉₀ satisfy the (II)-2.
[29] The CAM according to any one of [21] to [28],
in which the CAM is for a solid lithium secondary battery.
[30] An electrode for lithium secondary batteries, including the CAM according to any one of [21] to [29].
[31] A lithium secondary battery including the electrode for lithium secondary batteries according to [30].

### EXAMPLES

Hereinafter, the present invention will be described with reference to Examples, but the present invention is not limited thereto.

### <Measurement of α and β>

XPS analysis of the CAM was carried out according to the methods described in [Measurement method of α] and [Measurement method of β] above, and α and β were measured.

<Measurement of S_{Li} and I_{Li}>

XPS analysis of the CAM was carried out according to the methods described in [Measurement method of α] and [Measurement method of β] above, and S_{Li} and I_{Li} were measured.

### <Method for Confirming Concentration Portion>

A cross section of the CAM was acquired by the method described in [Method for acquiring cross section] above, TEM analysis was performed, and the cross section was confirmed according to the method described in [Method for confirming concentration portion] above.

### <Composition Analysis of CAM>

The composition analysis of CAM was carried out according to the method described in [Composition analysis] above.

### [Measurement of BET Specific Surface Area]

The specific surface area of the CAM was analyzed according to the method described in [Measurement of BET specific surface area] above.

D₁₀, D₉₀, and D₅₀ were analyzed by the method described in [Measurement of D₁₀, D₉₀, and D₅₀] above.

### <Method for Confirming Layered Structure>

It was confirmed whether the CAM had a layered structure or not by the method described in [Method for confirming layered structure] above.

A solid lithium ion secondary battery was manufactured according to the method described in [Measurement of initial discharge capacity] above, and a charging and discharging test was carried out on the manufactured solid lithium secondary battery according to the method described in <Charging and discharging test> above to evaluate the battery performance based on the value of the discharge capacity.

### Example 1

### (Production of CAM1)

After water was poured into a reaction vessel equipped with a stirrer and an overflow pipe, a sodium hydroxide aqueous solution was added thereto, and the liquid temperature was retained at 50° C.

A nickel sulfate aqueous solution, a cobalt sulfate aqueous solution, and a manganese sulfate aqueous solution were mixed with a molar ratio of Ni, Co, and Mn of 0.6:0.2:0.2, thereby preparing a mixed raw material solution 1.

Next, the mixed raw material solution 1 was continuously added to a reaction vessel under stirring, using an ammonium sulfate aqueous solution as a complexing agent. A sodium hydroxide aqueous solution was dropwise added to the mixed solution in the reaction vessel under a condition in which the pH of the solution was 12.1 (in a case where the temperature of the aqueous solution was 40° C.), thereby obtaining a reaction precipitate.

The obtained reaction precipitate was washed, dewatered by a centrifugal separator, washed, dewatered, and dried at 105° C. for 20 hours to obtain an MCC1 which was a nickel-cobalt-manganese composite hydroxide.

### (Preparation Step of Coating Material Raw Material 1)

133 g of H₂O₂ water having a concentration of 30% by mass, 151 g of pure water, and 6.8 g of niobium oxide hydrate Nb₂O₅·3H₂O (content: 72% by mass) were mixed with each other. Next, 13 g of ammonia water having a concentration of 28% by mass was added thereto, and the mixture was stirred. Furthermore, 1.9 g of LiOH·H₂O was added thereto to obtain a coating material raw material 1 containing Nb.

The coating material raw material 1 was sprayed onto the MCC 1 using a rolling fluidity device (manufactured by Paulick Co., Ltd., MP-01) at a proportion of Nb/(Ni+Co+Mn)=1 mol %.

Thereafter, a lithium hydroxide monohydrate powder was weighed and mixed at a proportion of Li/(Ni+Co+Mn)=1.03, and primary sintering was carried out at 650° C. for 5 hours in an oxygen atmosphere.

Next, main sintering was carried out at 840° C. for 5 hours in an oxygen atmosphere to obtain a main sintered product 1.

The obtained main sintered product 1 was crushed with a mass colloider-type crusher to obtain a crushed product 1.

The crushed product 1 was dried at 120° C. for 10 hours in a vacuum atmosphere. Thereafter, the coating material raw material 1 was sprayed onto the crushed product 1 at a proportion of Nb/(Ni+Co+Mn)=0.61 mol % using the above-described rolling fluidity device. In this case, a flow rate of the high-pressure air in the two-fluid spray nozzle of the above-described rolling fluidity device was 30 NL/min.

### (Heat Treatment Step)

The crushed product 1 sprayed with the coating material raw material 1 was heat-treated at 200° C. for 5 hours in an oxygen atmosphere to obtain a CAM1.

### [Evaluation of CAM1]

The value of α of the CAM1 was 0.79, and the value of β thereof was 0.13. The BET specific surface area was 0.5 m²/g. (D₉₀-D₁₀)/D₅₀ was 0.56. A content of Mn with respect to 1 mol of the total amount of the element M2 was 0.20 mol. The discharge capacity of the solid lithium secondary battery of the CAM1 was 176 mAh/g. The CAM1 had a layered structure. Table 1 shows x, a, b, c, d, e, and 8 in the compositional formula (I), the element M1, the element M2, the element Z, S_{Li}, and I_{Li} of CAM1, and the presence or absence of the concentration portion. Table 1 also shows the results of subsequent examples and comparative examples.

### Example 2

### (Production of CAM2)

The MCC1 and a lithium hydroxide monohydrate powder were weighed and mixed with each other at a molar ratio of Li/(Ni+Co+Mn)=1.03, and primary sintering was carried out at 650° C. for 5 hours in an oxygen atmosphere to obtain a primary sintered product 2.

Using the same rolling fluidity device as in Example 1, the coating material raw material 1 was sprayed onto the primary sintered product 2 at a proportion of Nb/(Ni+Co+Mn)=1 mol %, and in an oxygen atmosphere, the primary sintered product 2 was subjected to main sintering at 860° C. for 5 hours to obtain a main sintered product 2.

The obtained main sintered product 2 was crushed with a mass colloider-type crusher to obtain a crushed product 2.

The crushed product 2 was dried at 120° C. for 10 hours in a vacuum atmosphere. Subsequently, the coating material raw material 1 was sprayed onto the crushed product 2 at a proportion of Nb/(Ni+Co+Mn)=0.48 mol % using the above-described rolling fluidity device. In this case, a flow rate of the high-pressure air in the two-fluid spray nozzle of the above-described rolling fluidity device was 30 NL/min.

### (Heat Treatment Step)

The crushed product 2 sprayed with the coating material raw material 1 was heat-treated at 200° C. for 5 hours in an oxygen atmosphere to obtain a CAM2.

### [Evaluation of CAM2]

The value of α of the CAM2 was 0.74, and the value of β thereof was 0.09. The BET specific surface area was 0.4 m²/g. (D₉₀-D₁₀)/D₅₀ was 0.59. A content of Mn with respect to 1 mol of the total amount of the element M2 was 0.19 mol. The discharge capacity of the solid lithium secondary battery of the CAM2 was 179 mAh/g. The CAM2 had a layered structure.

### Example 3

### (Production of CAM3)

### (Preparation Step of Coating Material Raw Material 2)

3,300 g of pure water and 100 g of tungsten oxide WO₃ were mixed with each other. Furthermore, 110 g of LiOH·H₂O was added thereto to obtain a coating material raw material 2 containing W.

Using the same rolling fluidity device as in Example 1, the coating material raw material 2 was sprayed onto the MCC1 at a proportion of W/(Ni+Co+Mn)=1 mol %.

A lithium hydroxide monohydrate powder was weighed and mixed at a proportion of Li/(Ni+Co+Mn)=1.03, and primary sintering was carried out at 650° C. for 5 hours in an oxygen atmosphere. Next, main sintering was carried out at 840° C. for 5 hours in an oxygen atmosphere to obtain a main sintered product 3.

The obtained main sintered product 3 was crushed with a mass colloider-type crusher to obtain a crushed product 3.

The crushed product 3 was dried at 120° C. for 10 hours in a vacuum atmosphere. Thereafter, the coating material raw material 1 was sprayed onto the crushed product 3 at a proportion of Nb/(Ni+Co+Mn)=0.99 mol % using the above-described rolling fluidity device. In this case, a flow rate of the high-pressure air in the two-fluid spray nozzle of the above-described rolling fluidity device was 30 NL/min.

### (Heat Treatment Step)

The crushed product 3 sprayed with the coating material raw material 1 was heat-treated at 200° C. for 5 hours in an oxygen atmosphere to obtain a CAM3.

### [Evaluation of CAM3]

The value of α of the CAM3 was 0.87, and the value of β thereof was 0.15. The BET specific surface area was 0.4 m²/g. (D₉₀-D₁₀)/D₅₀ was 0.62. A content of Mn with respect to 1 mol of the total amount of the element M2 was 0.20 mol. The discharge capacity of the solid lithium secondary battery of the CAM3 was 175 mAh/g. The CAM3 had a layered structure.

### Comparative Example 1

### (Production of CAM-C1)

The MCC1 and a lithium hydroxide monohydrate powder were weighed and mixed with each other at a molar ratio of Li/(Ni+Co+Mn)=1.03, and primary sintering was carried out at 650° C. for 5 hours in an oxygen atmosphere to obtain a primary sintered product C1.

Using the same rolling fluidity device as in Example 1, the coating material raw material 1 was sprayed onto the primary sintered product C1 at a proportion of Nb/(Ni+Co+Mn)=1 mol %. Next, main sintering was carried out at 860° C. for 5 hours in an oxygen atmosphere to obtain a main sintered product C1.

The obtained main sintered product C1 was crushed with a mass colloider-type crusher to obtain a CAM-C1.

### [Evaluation of CAM-C1]

The value of α of the CAM-C1 was 0.20, and the value of β thereof was 0.04. The BET specific surface area was 0.4 m²/g. (D₉₀-D₁₀)/D₅₀ was 0.57. A content of Mn with respect to 1 mol of the total amount of the element M2 was 0.19 mol. The discharge capacity of the solid lithium secondary battery of the CAM-C1 was 161 mAh/g. The CAM-C1 had a layered structure.

### Comparative Example 2

### (Production of CAM-C2)

Using the same rolling fluidity device as in Example 1, the coating material raw material 1 was sprayed onto the MCC1 at a proportion of Nb/(Ni+Co+Mn)=1 mol %. Furthermore, a lithium hydroxide monohydrate powder was weighed and mixed at a proportion of Li/(Ni+Co+Mn)=1.03, and primary sintering was carried out at 650° C. for 5 hours in an oxygen atmosphere.

Next, main sintering was carried out at 840° C. for 5 hours in an oxygen atmosphere to obtain a main sintered product C2.

The obtained main sintered product was crushed with a mass colloider-type crusher to obtain a CAM-C2.

### [Evaluation of CAM-C2]

The value of α of the CAM-C2 was 0.08, and the value of β thereof was 0.02. The BET specific surface area was 0.7 m²/g. (D₉₀-D₁₀)/D₅₀ was 0.55. A content of Mn with respect to 1 mol of the total amount of the element M2 was 0.20 mol. The discharge capacity of the solid lithium secondary battery of the CAM-C2 was 152 mAh/g. The CAM-C2 had a layered structure.

### Comparative Example 3

### (Production of CAM-C3)

The MCC1 and a lithium hydroxide monohydrate powder were weighed and mixed with each other at a molar ratio of Li/(Ni+Co+Mn)=1.03, and primary sintering was carried out at 650° C. for 5 hours in an oxygen atmosphere. Next, main sintering was carried out at 840° C. for 5 hours in an oxygen atmosphere to obtain a main sintered product C3.

The obtained main sintered product C3 was crushed with a mass colloider-type crusher to obtain a crushed product C3.

The crushed product C3 was dried at 120° C. for 10 hours in a vacuum atmosphere. Using the same rolling fluidity device as in Example 1, the coating material raw material 1 was sprayed on the crushed product C3 at a proportion of Nb/(Ni+Co+Mn)=1.5 mol %. In this case, a flow rate of the high-pressure air in the two-fluid spray nozzle of the above-described rolling fluidity device was 100 NL/min.

### (Heat Treatment Step)

The crushed product C3 sprayed with the coating material raw material 1 was heat-treated at 200° C. for 5 hours in an oxygen atmosphere to obtain a CAM-C3.

### [Evaluation of CAM-C3]

The value of α of the CAM-C3 was 0.42, and the value of β thereof was 0.05. The BET specific surface area was 2.4 m²/g. (D₉₀-D₁₀)/D₅₀ was 0.62. A content of Mn with respect to 1 mol of the total amount of the element M2 was 0.19 mol. The discharge capacity of the solid lithium secondary battery of the CAM-C3 was 171 mAh/g. The CAM-C3 had a layered structure.

### Comparative Example 4

### (Production of CAM-C4)

The MCC1 and a lithium hydroxide monohydrate powder were weighed and mixed with each other at a molar ratio of Li/(Ni+Co+Mn)=1.03, and primary sintering was carried out at 650° C. for 5 hours in an oxygen atmosphere. Next, main sintering was carried out at 840° C. for 5 hours in an oxygen atmosphere to obtain a main sintered product C4.

The obtained main sintered product C4 was crushed with a mass colloider-type crusher to obtain a crushed product C4.

The crushed product C4 was dried at 120° C. for 10 hours in a vacuum atmosphere. Using the same rolling fluidity device as in Example 1, the coating material raw material 1 was sprayed on the crushed product C4 at a proportion of Nb/(Ni+Co+Mn)=0.80 mol % to obtain a CAM-C4. In this case, the two-fluid high-pressure air amount of the above-described rolling fluidity device was 30 NL/min.

### [Evaluation of CAM-C4]

The value of α of the CAM-C4 was 0.64, and the value of β thereof was 0.07. The BET specific surface area was 1.0 m²/g. (D₉₀-D₁₀)/D₅₀ was 0.68. A content of Mn with respect to 1 mol of the total amount of the element M2 was 0.22 mol. The discharge capacity of the solid lithium secondary battery of the CAM-C4 was 171 mAh/g. The CAM-C4 had a layered structure.

Table 1 shows physical properties, compositions, and the like of Examples 1 to 3 and Comparative Examples 1 to 4.

TABLE 1

| | | | | | Presence or | | | | | |
|---|---|---|---|---|---|---|---|---|---|---|
| | | | | | absence of | | | | | |
| | | | | | concentration | | | | | |
| | M1 | M2 | α | β | portion | x | a | b | c | d |
| | — | — | — | — | — | — | — | — | — | — |
| Example 1 | Nb | Ni, | 0.79 | 0.13 | Y | 1.05 | 0.58 | 0.20 | 0.20 | 0 |
| | | Co, | | | | | | | | |
| | | Mn | | | | | | | | |
| Example 2 | Nb | Ni, | 0.74 | 0.09 | Y | 1.06 | 0.59 | 0.20 | 0.19 | 0 |
| | | Co, | | | | | | | | |
| | | Mn | | | | | | | | |
| Example 3 | Nb, | Ni, | 0.87 | 0.15 | Y | 1.11 | 0.58 | 0.20 | 0.20 | 0 |
| | W | Co, | | | | | | | | |
| | | Mn | | | | | | | | |
| Comparative | Nb | Ni, | 0.20 | 0.04 | Y | 1.05 | 0.60 | 0.20 | 0.19 | 0 |
| Example 1 | | Co, | | | | | | | | |
| | | Mn | | | | | | | | |
| Comparative | Nb | Ni, | 0.08 | 0.02 | Y | 1.04 | 0.59 | 0.20 | 0.20 | 0 |
| Example 2 | | Co, | | | | | | | | |
| | | Mn | | | | | | | | |
| Comparative | Nb | Ni, | 0.42 | 0.05 | N | 1.05 | 0.60 | 0.19 | 0.19 | 0 |
| Example 3 | | Co, | | | | | | | | |
| | | Mn | | | | | | | | |
| Comparative | Nb | Ni, | 0.64 | 0.07 | N | 1.08 | 0.58 | 0.20 | 0.21 | 0 |
| Example 4 | | Co, | | | | | | | | |
| | | Mn | | | | | | | | |

| | | | | | | BET | | |
|---|---|---|---|---|---|---|---|---|
| | | | | | | specific | | Initial |
| | | | | | | surface | (D₉₀ − | discharge |
| | e | δ | Z | S_{Li} | I_{Li} | area | D₁₀)/D₅₀ | capacity |
| | — | — | — | — | — | m²/g | — | mAh/g |
| Example 1 | 0.02 | 2 | None | 1.9 | 15 | 0.5 | 0.56 | 176 |
| Example 2 | 0.02 | 2 | None | 2.8 | 22 | 0.4 | 0.59 | 179 |
| Example 3 | 0.02 | 2 | None | 2.2 | 14 | 0.4 | 0.62 | 175 |
| Comparative | 0.01 | 2 | None | 10.4 | 48 | 0.4 | 0.57 | 161 |
| Example 1 | | | | | | | | |
| Comparative | 0.01 | 2 | None | 17.5 | 77 | 0.7 | 0.55 | 152 |
| Example 2 | | | | | | | | |
| Comparative | 0.02 | 2 | None | 2.3 | 39 | 2.4 | 0.62 | 171 |
| Example 3 | | | | | | | | |
| Comparative | 0.01 | 2 | None | 2.5 | 27 | 1.0 | 0.68 | 171 |
| Example 4 | | | | | | | | |

In Examples 1 to 3 produced by the method including the manufacturing step (A) or the manufacturing step (B) and the step of mixing the obtained sintered product with the coating material raw material, α and β of CAM satisfied the ranges of the present invention, and the element M1 and the element M2 were present on the surface of the secondary particles and inside the secondary particles at specific ratios. It was found that, in a case where such a CAM was used, the initial discharge capacity of the lithium secondary battery was 172 mAh/g or more.

In Comparative Examples 1 and 2 produced without carrying out the manufacturing step (A) or the manufacturing step (B), and in Comparative Examples 3 and 4 produced without mixing the sintered product with the coating material raw material, α and β of the CAM did not satisfy the ranges of the present invention. It was found that, in a case where such a CAM was used, the initial discharge capacity of the lithium secondary battery was approximately 150 to 170 mAb/g.

### REFERENCE SIGNS LIST

1 Separator
2 Cathode
2a Cathode active material layer
2b Cathode current collector layer
3 Anode
4 Electrode group
5 Battery can
6 Electrolytic solution
7 Top insulator
8 Sealing body
10 Lithium secondary battery
21 Cathode lead
31 Anode lead
100 Laminate
110 Cathode
111 Cathode active material layer
112 Cathode current collector
113 External terminal
120 Anode
121 Anode active material layer 122 Anode current collector 123 External terminal 130 Solid electrolyte layer 200 Exterior body 200a Opening portion 1000 All-solid-state lithium secondary battery

1. A cathode active material for lithium secondary batteries, comprising:
secondary particles which are an aggregate of primary particles,
wherein the cathode active material for lithium secondary batteries has a layered structure,
the cathode active material for lithium secondary batteries contains an element M1 and an element M2,
the element M1 is at least one element selected from the group consisting of Nb, W, Mo, Ta, La, B, and P,
the element M2 is at least one element selected from the group consisting of Ni, Co, and Mn, and
the following (1) and (2) are satisfied,
(1) α, which is a ratio of an atomic concentration (atomic %) of the element M1 present on a surface of the secondary particles to a total amount of the atomic concentration (atomic %) of the element M1 and an atomic concentration (atomic %) of the element M2 present on the surface of the secondary particles, which are obtained by X-ray photoelectron spectroscopy (XPS) analysis, is 0.6 or more and 1 or less,
(2) β, which is a ratio of an atomic concentration (atomic %) of the element M1 present inside the secondary particles to a total amount of the atomic concentration (atomic %) of the element M1 and an atomic concentration (atomic %) of the element M2 present inside the secondary particles, which are obtained by the X-ray photoelectron spectroscopy (XPS) analysis, is 0.08 or more and 0.20 or less.

2. The cathode active material for lithium secondary batteries according to claim 1,
wherein a concentration portion of the element M1 is provided at a grain boundary of the primary particles in a cross section of the secondary particles, observed by transmission electron microscope-energy dispersive X-ray spectroscopy.

3. The cathode active material for lithium secondary batteries according to claim 1,
wherein a content of Mn is 0.03 mol or more with respect to 1 mol of a total amount of the element M2.

4. The cathode active material for lithium secondary batteries according to claim 1,
wherein the cathode active material for lithium secondary batteries is represented by the following compositional formula (I), 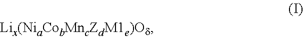
(in the compositional formula (I), 0.98≤x≤1.80, 0.3<a≤1, 0≤b≤0.3, 0.03≤c≤0.7, 0≤d≤0.05, 0<e≤0.05, a+b+c+d+e=1, and 2≤δ<3 are satisfied, Z is at least one element selected from the group consisting of Al, Zr, and Ti, and M1 is at least one element selected from the group consisting of Nb, W, Mo, Ta, La, B, and P).

5. The cathode active material for lithium secondary batteries according to claim 1,
wherein S_{Li}, which is a ratio of an atomic concentration of Li present on the surface of the secondary particles to the atomic concentration of the element M1 present on the surface of the secondary particles, which are obtained by the X-ray photoelectron spectroscopy (XPS) analysis, is 1 or more and 4 or less.

6. The cathode active material for lithium secondary batteries according to claim 1,
wherein I_{Li}, which is a ratio of an atomic concentration of Li present inside the secondary particles to the atomic concentration of the element M1 present inside the secondary particles, which are obtained by the X-ray photoelectron spectroscopy (XPS) analysis, is 10 or more and 50 or less.

7. The cathode active material for lithium secondary batteries according to claim 1,
wherein a BET specific surface area is 0.2 m²/g or more and 2 m²/g or less.

8. The cathode active material for lithium secondary batteries according to claim 1,
wherein D₁₀, D₅₀, and D₉₀ satisfy the following (II),
$$( D 90 - D 10 ) / D 50 \leq 1. , \qquad ( II )$$
(D₁₀ is a 10% cumulative volume particle size of the cathode active material for lithium secondary batteries, D₅₀ is a 50% cumulative volume particle size of the cathode active material for lithium secondary batteries, and D₉₀ is a 90% cumulative volume particle size of the cathode active material for lithium secondary batteries).

9. The cathode active material for lithium secondary batteries according to claim 1,
wherein the cathode active material for lithium secondary batteries is for a solid lithium secondary battery.

10. An electrode for lithium secondary batteries, comprising:
the cathode active material for lithium secondary batteries according to claim 1.

11. A lithium secondary battery, comprising:
the electrode for lithium secondary batteries according to claim 10.
